(19) United States
(12) Patent Application Publication
(10) Pub. No.: US 2004/0136315 A1
(43) Pub. Date: Jul. 15, 2004

(54) Method for retrieving sequences having minimum PAPR in OFDM communication system

(76) Inventor: Seok-Il Chang, Gyeonggi-Do (KR)

Correspondence Address: FLESHNER & KIM, LLP, P.O. BOX 221200, CHANTILLY, VA, 20153, US

(21) Appl. No.: 10/745,638

(22) Filed: Dec. 29, 2003

(30) Foreign Application Priority Data
Dec. 27, 2002 (KR) 85516/2002

(51) Int. Cl. H04J 11/00; H04L 12/26

(52) U.S. Cl. 370/206; 370/252

(57) ABSTRACT

In a method for retrieving sequences having a minimum PAPR (peak to average power ratio) in an OFDM (orthogonal frequency division multiplexing) system, by using characteristics in which all sequences of the OFDM system are classified into cosets having the same PAPR, PAPRs of sequences in which early two elements are fixed as “0” are calculated. A sequence having a minimum PAPR is selected from among the calculated PAPRs, and sequences allocated to the coset in which the selected sequence is included are retrieved as sequences having the minimum PAPR. In addition, according to PAPRs of sequences having early two elements fixed as “0” and the number of sequences of a coset including the sequences having early two elements fixed as “0,” it is possible to quickly and efficiently analyze PAPR distribution of all sequences. Accordingly, the OFDM system can be designed as a device having a low PAPR and low dynamic range.

### BACKGROUND OF THE INVENTION

1. Field of the Invention

The present invention relates to a method and apparatus for reducing a PAPR (peak to average power ratio) in order to prevent performance deterioration in an OFDM (orthogonal frequency division multiplexing) communication system, and in particular to a method and apparatus for efficiently and quickly retrieving sequences having a minimum PAPR.

2. Background of the Related Art

Generally, in a multi-carrier transmission system such as an OFDM (orthogonal frequency division multiplexing) system, information is simultaneously transmitted through a uniformly distributed carrier frequency. Accordingly, in the OFDM system, a high data transmission rate can be obtained. Because data is distributed to the whole transmission band in data transmission, the OFDM system is stable even in frequency selective fading and narrow-band interference environments. The OFDM method has better performance in a multipath and mobile communication environment. It can be used for various communication systems such as a local area network, a DAB (digital audio broadcasting) network, a DVB (digital video broadcasting) network, a radio ATM (asynchronous transfer mode) network, an Internet protocol network and in an IMT-2000 UMTS (universal mobile telecommunication system).

However, the OFDM communication system has a high PAPR (peak to average power ratio) problem. In general, in the OFDM system, peak envelope power of a multi-carrier signal is increased according to the number of carriers. For example, in the OFDM system, when the n-number of signals are overlapped in the same phase, maximum power of a multi-carrier signal is increased N-times of average power. Accordingly, a PAPR defined as a ratio of maximum power to average power of a multi-carrier is increased, when a PAPR value is high, an amplifier having very wide dynamic range is required for the OFDM communication system. In addition, an ADC (analog to digital converter) having a complicated construction and a DAC (digital to analog converter) are required. Even in the OFDM system using an amplifier having a wide dynamic range, performance of the amplifier may be lowered because of large amplitude variation or distortion of a signal or the amplifier operating in a non-linear range.

Accordingly, in order to solve the above-mentioned problems caused by a high PAPR in the OFDM system, several methods have been proposed.

One method is for reducing a PAPR by limiting a maximum amplitude of a signal so as to be not greater than a prescribed value by using clipping. However, in the clipping method, by limiting a maximum amplitude by multiplying an OFDM signal by a rectangular window, signal distortion occurs, bit error rate is increased, and frequency characteristics are deteriorated.

Another method for reducing a PAPR is a method of using an error correcting code. In the error correcting code method, in order to reduce a total PAPR, an OFDM signal is generated by selecting only a codeword having lower maximum power on the basis of a block coding method. However, in the error correcting code method, in order to select a codeword having lower PAPR, a high retrieval time is required because all possible codewords have to be retrieved.

Yet another method for reducing a PAPR is a structural method for defining a binary Golay complementary sequence and generating such a sequence. The Golay complementary sequence is a pair of sequences having an addition of an aperiodic autocorrelation function as 0 about all shifts except 0. In the case of generating an OFDM signal by using the Golay complementary sequence, a PAPR is not greater than 3 dB, and it can be checked by using correlation characteristics of the Golay complementary sequence. In addition, the Golay complementary sequence can be extended to a polyphase sequence appropriate for multilevel phase modulation. However, in the Golay complementary sequence generating method, in order to use a polyphase sequence, an attritional retrieving process for retrieving all polyphase sequences has to be performed. In addition, in order to perform coding and decoding, a memory for storing codewords is required, and accordingly the method is complex.

In order to solve the above-mentioned problem, a structural method capable of reducing a PAPR in an OFDM system having comparatively less carriers while maintaining a coding rate and an error correcting performance by using correlation between the Golay complementary sequence and a RM (reed muller) code was disclosed in Davis and Jedwab (“Peak-to-mean power control in OFDM, Golay complementary sequences and Reed-Muller codes,” IEEE Trans. Inform. Theory, vol. 45, pp. 2397-2411, November 1997). However, in the method, a coding rate is remarkably reduced attributed to the increase in the number of carriers.

In addition, a SLM (selected mapping) method and a PTS (partial transmit sequence) method are methods for reducing a PAPR in the probability aspect in an OFDM communication system using many carriers.

The SLM method is used for generating M-number of sequences for indicating the same information using different methods, selecting a sequence having the smallest PAPR characteristic among them and transmitting that sequence. Because the SLM method selectively transmits a sequence having the smallest PAPR among the M-number of sequences, general PAPR characteristics can be improved. However, in the SLM method, a receiving side requires additional information for restoring an original signal, herein, the additional information may have important influences on system performance.

The PTS method is used for dividing an input sequence into independent parts, adding a phase for minimizing a PAPR to each part and transmitting each part. In the PTS method, by selectively transmitting a sequence having the smallest PAPR among several sequences using various phases, general PAPR characteristics can be improved. However, the PTS method also requires additional information in order to restore the original signal.

As described-above, in order to solve the problems caused by a high PAPR in the OFDM system, many methods for reducing a PAPR have been presented, however, each method have certain problems therein.

Accordingly, in order to solve the problems caused by a high PAPR, there is a need to accurately grasp PAPR distribution of input sequences in an OFDM system.

The above reference is incorporated by reference herein where appropriate for appropriate teachings of additional or alternative details, features and/or technical background, and contain nonessential subject matter relating to background related to the technology of the invention.

### SUMMARY OF THE INVENTION

An object of the invention is to solve at least the above problems and/or disadvantages and to provide at least the advantages described hereinafter.

In order to solve the above-mentioned problems, it is an object of the present invention to provide a method and apparatus for efficiently and quickly retrieving among all input sequences those sequences having a minimum PAPR (peak to average power ratio) by using characteristics in which sequences are classified into cosets having the same PAPR in an OFDM (orthogonal frequency division multiplexing) communication system.

It is another object of the present invention to provide a method and apparatus for grasping PAPR distribution of input sequences in an OFDM communication system quickly and efficiently.

It is another object of the present invention to provide a method for implementing in a device in an OFDM communication system, having a lower PAPR on the basis of PAPR distribution state of sequences.

In order to achieve the above-mentioned objects, a method for retrieving sequences having a minimum PAPR (peak to average power ratio) in an OFDM (orthogonal frequency division multiplexing) system includes classifying all input sequences into cosets having the same PAPR, retrieving sequences in which early two elements are fixed as a prescribed value, detecting sequences having a minimum PAPR among the retrieved sequences, selecting cosets in which the detected sequences are included, and extracting sequences included in the selected cosets respectively. In an embodiment of the present invention, early two elements are the first two elements of a sequence, and the prescribed value is “0.”

Sequences generated by conversion for shifting by a prescribed time on a timing axis and conversion for multiplying by a random phase are allocated to the same coset in the classifying step.

A sequence a(φ) and a sequence a^{(m)} are allocated to the same coset on the basis of a sequence a=(a₀,a₁, . . . ,a_{N-1}) in the classifying step when the number of carriers is N and a M-PSK modulation method is used, and wherein

a(φ)=(a₀+φ, a₁+φ, . . . , a_{N-1}+φ), where φ=0,1, . . . M−1,

a^{(m)}=(a^{(m)}₀, a^{(m)}₁, . . . , a^{(m)}_{N-1}), where m=0,1,2, . . . , M−1, and

an i-th sequence of the sequence a^{(m)} is

a^{(m)}ᵢ=aᵢ+im (mod M), where i=0,1, . . . , N−1.

A sequence a=(0,0,a₂,a₃, . . . , a_{N-1}), aᵢ=0,1,2, . . . M−1 is retrieved in the retrieving step when the number of carriers is N and a M-PSK modulation method is used.

The retrieving step includes the sub-steps of calculating PAPRs of the retrieved sequences, selecting a minimum PAPR among the calculated PAPRs, and detecting sequences having the smallest PAPR among the retrieved sequences.

The method further includes calculating PAPRs of sequences in which the early two elements are fixed as a prescribed value, and analyzing PAPR distribution of all the input sequences by using the number of sequences respectively allocated to cosets in which the sequences having the early two elements fixed as the prescribed value are included and using the calculated PAPRs.

The analyzed PAPR distribution state is used for determining a dynamic range required for a device of the OFDM system.

A method for retrieving sequences having a minimum PAPR (peak to average power ratio) in an OFDM (orthogonal frequency division multiplexing) system includes retrieving sequences in which early two elements are fixed as “0,” calculating PAPRs of the retrieved sequences, selecting a minimum PAPR among the calculated PAPRs and detecting sequences having the minimum PAPR, selecting cosets in which the detected sequences are included, and generating sequences respectively included in the selected cosets.

Sequences having the early two elements fixed as “0” are included in different cosets, and sequences in the same coset have the same PAPR characteristics.

Sequences a=(0,0,a₂,a₃, . . . , aᵢ, . . . , a_{N-1}) are retrieved in the retrieving step when the number of carriers is N and a M-PSK modulation method is used, wherein aᵢ=0,1,2, . . . , M−1 and i=2,3, . . . , N−1.

Sequences having the same PAPR characteristics as the detected sequence's PAPR are generated by a first conversion for multiplying the detected sequence and a prescribed phase, and a second conversion for shifting the detected sequence by a prescribed time on a timing axis in the generating step.

Sequences generated by the first conversion are

a(φ)=(a₀+φ, a₁+φ, . . . , a_{N-1}+φ), where φ=0,1, . . . M−1.

Sequences generated by the second conversion are

a^{(m)}=(a^{(m)}₀,a^{(m)}₁, . . . , a^{(m)}_{N-1}), where m=0,1,2, . . . , M−1.

When the number of carriers is N and a M-PSK modulation method is used, an i-th sequence of the sequence a^{(m)} is defined as

a^{(m)}ᵢ=aᵢ+im (mod M), where i=0,1, . . . , N−1.

In addition, an embodiment of the invention may be realized through an apparatus performing the aforementioned method for retrieving sequences having a minimum PAPR in an OFDM system.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 shows a construction of an OFDM (orthogonal frequency division multiplexing) communication system;

FIG. 2 is a flow chart illustrating a method for retrieving sequences having a minimum PAPR in an OFDM communication system in accordance with the present invention; and

FIG. 3 shows an example of a coset in accordance with the present invention.

### DETAILED DESCRIPTION OF PREFERRED EMBODIMENTS

The accompanying drawings, which are included to provide a further understanding of the invention and are incorporated in and constitute a part of this specification, illustrate embodiments of the invention and together with the description serve to explain the principles of the invention.

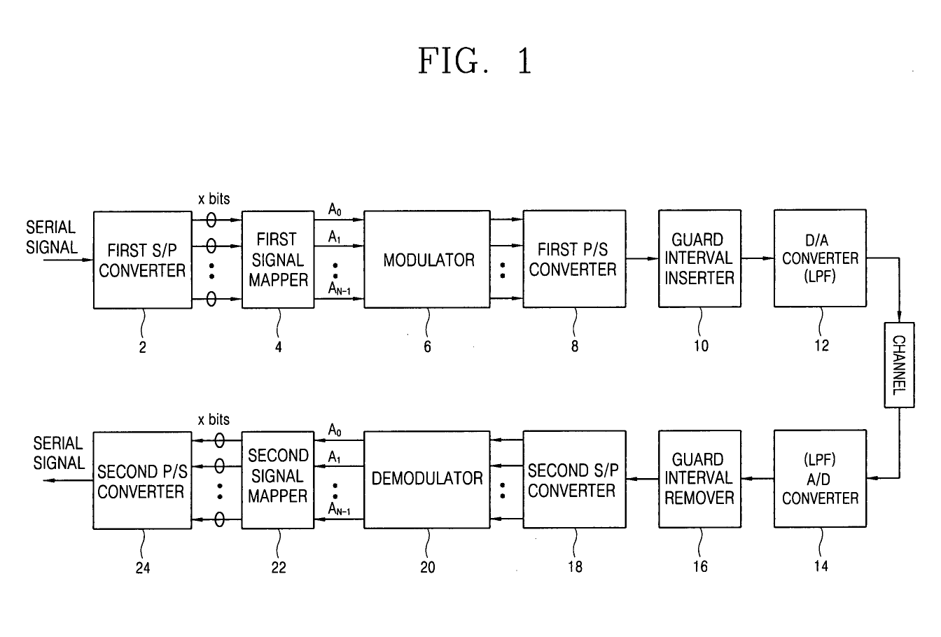

FIG. 1 shows a construction of an OFDM (orthogonal frequency division multiplexing) communication system.

As depicted in FIG. 1, the OFDM communication system includes a transmitting unit and a receiving unit. The transmitting unit includes a first serial to parallel converter 2 for converting a serial input digital signal into a parallel signal, a first signal mapper 4 for converting a digital signal outputted from the first serial to parallel converter 2 into a QPSK (quadrature phase shift keying) signal, a modulator 6 for modulating each signal parallel-outputted from the first signal mapper 4 by IDFT (inverse discrete Fourier transform), a first parallel to serial converter 8 for converting the signal parallel-outputted from the modulator 6 into a serial signal, a guard interval inserter for inserting a guard internal into the signal outputted from the first parallel to serial converter 8, and a digital to analog converter 12 for converting the digital signal outputted from the guard interval inserter 10 into an analog signal, removing noise thereof and transmitting the analog signal through a channel. The receiving unit includes an analog to digital converter 14 for removing noise from the signal received through the channel and converting it into a digital signal, a guard interval remover 16 for removing the guard interval from the signal outputted from, the analog to digital converter 14, a second serial to parallel converter 18 for converting the signal outputted from the guard interval remover 16 into a parallel signal, a demodulator 20 for demodulating the parallel signal from the second serial to parallel converter 18 respectively by a discrete Fourier transform, a second signal mapper 22 for converting a QPSK signal from the demodulator 20 into a digital signal, and a second parallel to serial converter 24 for converting the digital signal parallel-outputted from the second signal mapper 22 into a serial signal.

In general, an amplifier is required for transmission of the OFDM signal, however, it is not shown in FIG. 1.

The operation of the general OFDM communication system will now be described.

The first serial to parallel converter 2 converts a received serial digital signal into a parallel signal, the first signal mapper 4 performs mapping of the parallel signal so as to convert it into a QPSK signal, the modulator 6 converts the QPSK signal by the IDFT method, and the first parallel to serial converter 8 converts the modulated IDFT signal into a serial signal. The guard interval inserter 10 inserts a guard interval into the serial signal in order to prevent interference occurrence, and the digital to analog converter 12 converts the serial digital signal into an analog signal, cuts off noise through low pass filtering and transmits the analog signal through an allocated channel.

When the signal is received through the allocated channel, the analog to digital converter 14 removes noise from the received analog signal and converts the analog signal into a digital signal, the guard interval remover 16 removes the guard interval from the digital signal, and the second serial to parallel converter 18 converts the digital signal into a parallel signal. The demodulator 20 demodulates the parallel signal through DFT, the second signal mapper 22 performs mapping of the demodulated parallel signal into a digital signal, and the second parallel to serial converter 24 converts the parallel digital signal into a serial digital signal.

In the present invention, by using characteristics in which all sequences usable in a general OFDM communication system are classified into cosets having the same PAPR, a method for obtaining PAPR distribution of all sequences and quickly retrieving sequences having a minimum PAPR will be described.

The OFDM retriever according to the present invention may be applied to several nodes in the OFDM system shown in FIG. 1. In one embodiment of the present invention, the OFDM retriever is applied between the first signal mapper 4 and the modulator 6, and the OFDM retriever is able to retrieve the OFDM sequences having the minimum PAPR easily and calculate the PAPR distribution of all sequences easily, by using characteristics of the coefficients A₀,A₁, . . . , A_{N-1} of the OFDM signal. In another embodiment of the present invention, the OFDM retriever may also be applied between the demodulator 20 and the second signal mapper 22.

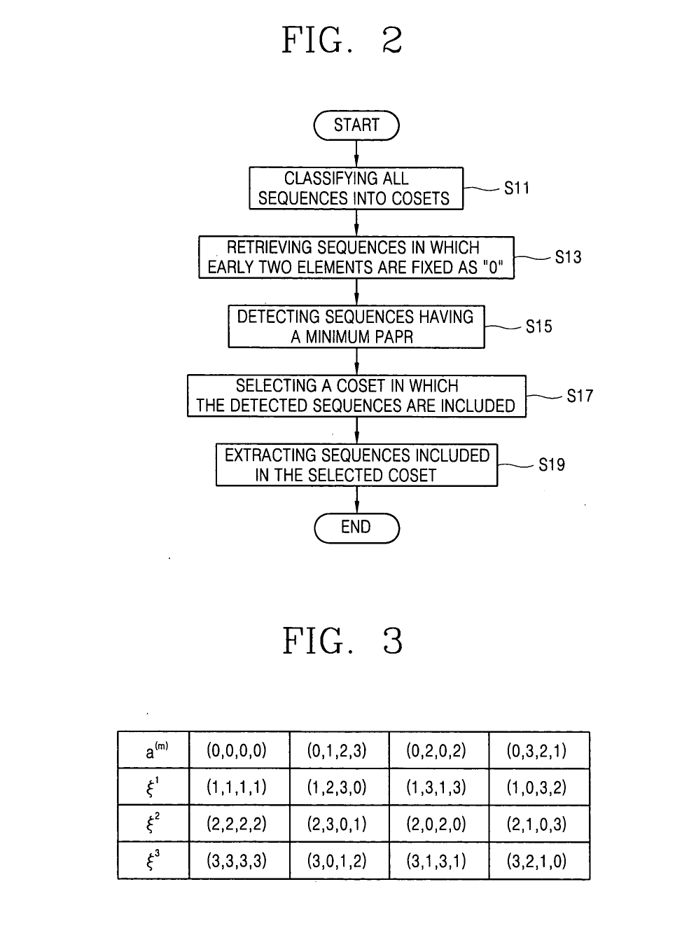

FIG. 2 is a flow chart illustrating a method for retrieving sequences having a minimum PAPR in an OFDM communication system in accordance with the present invention.

In the present invention, by using certain characteristics, all input sequences are classified into cosets having the same PAPR as shown at step S11. Sequences in which early two elements have a value of “0” are retrieved as shown at step S13, and a PAPR of each retrieved sequence is respectively calculated. In the present invention, a minimum PAPR is selected from among the calculated PAPRs, and a sequence having the minimum PAPR is selected as shown at step S15. A coset continuing the sequence having the minimum PAPR is selected as shown at step S17, and sequences of the selected coset are extracted as sequences having the minimum PAPR as shown at step S19.

First, a PAPR (peak to average power ratio) of an OFDM (orthogonal frequency division multiplexing) signal will be described in more detail.

In the OFDM system using an N-number of carriers, a modulation signal allocated to a k-th carrier in a given symbol section [0, T] is Aₖ(k=0,1, . . . N−1), an OFDM signal s(t) can be described as:

$$s ( t ) = {\sum }_{k = 0}^{N - 1} {A}_{k} {ⅇ}^{j 2 π kt / T} \qquad ( 1 )$$

In equation (1), Aₖ is one symbol of a signal constellation according to a modulation method.

A PAPR of an OFDM signal corresponded to equation (1) is a ratio of maximum instantaneous power to average power, and can be described as:

$$PAPR = {max}_{0 \leq t < T} \frac{{\vert s ( t ) \vert}^{2}}{E [ {\vert s ( t ) \vert}^{2} ]} \qquad ( 2 )$$

Herein, E is an expectation operator having an average.

Next, PAPR characteristics of an OFDM signal using a M-PSK modulation method will be described.

In the OFDM communication system using the M-PSK modulation method, PAPR of a generated OFDM signal has certain characteristics. A first characteristic (A) is that PAPR characteristics of an OFDM signal are not changed, although a prescribed phase is multiplied by an OFDM signal. A second characteristic (B) is that PAPR characteristics of an OFDM signal are not changed, although an OFDM signal is shifted by a prescribed time on a timing axis.

(A) First Characteristic

When ξ=exp(2πj/M), the i-th element Aᵢ can be described as Aᵢ=ξ^{a}^{ᵢ}, where aᵢ∈ {0,1, . . . , M−1}, a sequence A can be corresponded to a sequence a=(a₀,a₁, . . . , a_{N-1}). Accordingly, a signal s(t) in equation (1) can be described as:

$$s ( t ) = {\sum }_{k = 0}^{N - 1} {ξ}^{{a}_{k}} {W}^{kt} \qquad ( 3 )$$

Herein, W=exp(j2π/T).

Although a certain phase ξ^{φ} is multiplied by the OFDM signal s(t), PAPR characteristics of the signal s(t) are not varied, and the M-number of sequence a(φ)=(a₀+φ, a₁+φ, . . . , a_{N-1}+φ), where φ=0,1, . . . M−1 has the same PAPR with the sequence a. Herein, an addition operation is performed on a F_{M}(Field) (the addition operation is closed in a modulo M Field).

In more detail, when a signal obtained by multiplying the signal s(t) by the certain phase ξ^{φ} is s′(t), the s′(t) is defined as:

s′(t)=s(t)·ξ^{φ} (4)

A PAPR of s′(t) can be calculated by using equation (2).

$$\begin{matrix}PAPR \{ s ( t ) \} = {max}_{0 \leq t < T} \frac{{\vert {s}^{′} ( t ) \vert}^{2}}{E [ {\vert {s}^{′} ( t ) \vert}^{2} ]} = {max}_{0 \leq 1 < T} \frac{{s}^{′} ( t ) \cdot {{s}^{′} ( t )}^{*}}{E [ {s}^{′} ( t ) \cdot {{s}^{′} ( t )}^{*} ]} \\ = {max}_{0 \leq t < T} \frac{s ( t ) {ξ}^{φ} \cdot {s ( t )}^{*} {ξ}^{- φ}}{E [ s ( t ) {ξ}^{φ} \cdot {s ( t )}^{*} {ξ}^{- φ} ]} = {max}_{0 \leq t < T} \frac{s ( t ) \cdot {s ( t )}^{*}}{E [ s ( t ) \cdot {s ( t )}^{*} ]} \\ = {max}_{0 \leq t < T} \frac{{\vert s ( t ) \vert}^{2}}{E [ {\vert s ( t ) \vert}^{2} ]}\end{matrix} \qquad ( 5 )$$

Accordingly, a PAPR of the signal s′(t) is the same as a PAPR of the signal s(t).

(B)Second Characteristic

When an i-th element a^{(m)}ᵢ of a sequence a^{(m)}=(a^{(m)}₀,a^{(m)}₁, . . . , a^{(m)}_{N-1}) about a random integer m (m=0,1,2, . . . , M−1) is defined as

a^{(m)}ᵢ=aᵢ+im (mod M), i=0,1, . . . , N−1,

a PAPR of the M-number of sequence a^{(m)} is the same as a PAPR of the sequence a. In more detail, an OFDM signal s^{(m)}(t) corresponding to a^{(m)} can be described as:

_{S}^{(m)}(t)=ξ^{a}^{₀}+ξ^{a}^{₁}^{+m}W^{t}+ξ^{a}^{₂}^{+2m}W^{2t}+ . . . +ξ^{a}^{_{N-1}}^{+(N-1)m}W^{(N-1)t}

When τ=mT/M, s^{(m)}(t) can be described as:

_{S}^{(m)}(t)=ξ^{a}^{₀}+ξ^{a}^{₁}W^{t+τ}^{ₘ}+ξ^{a}^{₂}W^{2(t+τ}^{ₘ}⁾+ . . . +ξ^{a}^{_{N-1}}W^{(N-1)(t+τ}^{ₘ}⁾

In more detail, s^{(m)}(t)=s(t+τₘ), such that s^{(m)}(t) is a signal shifted by τₘ on a timing axis. The OFDM signal is a cycle signal having a cycle T, and a^{(m)} and a generate an OFDM signal having the same PAPR characteristics.

When the first characteristic (A) and the second characteristic (B) are synthesized, two conversions not changing PAPR characteristics of a signal exist, and the M²-number of sequences can generate signals having the same PAPR characteristics. When the number of carriers is N and M-PSK modulation method is used, the number of occurrable OFDM signals is MN, and a PAPR retriever in accordance with the present invention classifies the M^{N}-number of OFDM signals into cosets consisting of the M²-number of sequences having the same PAPR. Accordingly, the number of cosets is M^{N}/M²=M^{N-2}.

For example, in a QPSK modulation with N=4 and M=4, the number of sequences is M^{N}=4⁴=256. According to conversion by the first characteristic (A) and conversion by the second characteristic (B), the M²=4²=16 number of sequences have the same PAPR characteristics. Thus, in the PAPR retriever in accordance with the present invention, the total (256) number of sequences are classified into the M^{N-2}=4⁴⁻²=16 number of cosets according to conversion by the first characteristic (A) and conversion by the second characteristic (B) as shown at step S11.

FIG. 3 illustrates one coset among the sixteen cosets.

In more detail, in the PAPR retriever, by converting a (0,0,0,0) sequence by using the first and second characteristics (A) and (B), 15 sequences having the same PAPR with PAPR characteristics of the (0,0,0,0) sequence are generated. The PAPR retriever allocates the (0,0,0,0) sequence and the 15 generated sequences to one coset. Accordingly, the 16 sequences are allocated to one coset having the same PAPR. With reference to equation (1), an OFDM signal about the (0,0,0,0) sequence has a maximum PAPR value of N, sequences allocated to the coset in which the (0,0,0,0) sequence is allocated have the same PAPR characteristics. As described above, the PAPR retriever classifies all 256 sequences into 16 cosets.

For reference, it is known that input sequences having the same PAPR are generated by a certain rule, and in general, a coset having a (0,0,0,0) sequence can be generated by using a linear block code. For example, a coset about the sequence (0,0,0,0) is regarded as a block code having 16 codewords, and a generation matrix can be described. Herein, an operation of the linear block code is defined by the F4 (modulo 4 Field).

$$G = [ \begin{matrix}1111 \\ 0123\end{matrix} ]$$

In the OFDM system having N-number of carriers and using the M-PSK modulation method, in order to retrieve an input sequence having a minimum PAPR, a sequence in which early two elements of the input sequence are fixed as 0 while the rest of the elements are varied is considered. In more detail, only the following types of sequences are considered:

a=(0,0,a₂,a₃, . . . , aᵢ, . . . , a_{N-1}), where aᵢ=0,1,2, . . . M−1.

Finally, by considering only the M^{N}/M²=M^{N-2} number of sequences (included in that type) among the total M^{N} number of input sequences, an input sequence having a minimum PAPR can be retrieved.

In this example, Gaussian elimination can be applied to a generation matrix in the F4, and a generation matrix after applying the Gaussian elimination can be described as:

$$G = [ \begin{matrix}1032 \\ 0123\end{matrix} ] = [ \begin{matrix}{I}_{2} & P\end{matrix} ]$$

Further, a check matrix of the code can be described as following.

$$P = [ \begin{matrix}- {P}^{t} & {I}_{n - k}\end{matrix} ] = [ \begin{matrix}1210 \\ 2101\end{matrix} ]$$

In the check matrix, the coset including the (0,0,0,0) sequence, namely, codewords satisfying the check matrix, have a syndrome of (0, 0).

When block codes have different syndromes, they have characteristics included in different cosets. Sequences which are generated by the check matrix and have the same syndrome have the same PAPR. In general, a check matrix of the code can be described as:

P=[−P^{t}Iₙ₋₂]

where −P^{t} is a matrix having two columns. When early two elements of a sequence are fixed as 0, a syndrome is generated by the rest of the elements. In addition, the syndrome is generated by Iₙ₋₂, and when an input sequence is a=(0,0,a₂,a₃, . . . , a_{N-1}), a syndrome (S) has a form of S=(a₂,a₃, . . . , a_{N-1}).

Sequences of the a=(0,0,a₂,a₃, . . . , a_{N-1}) form are included in different cosets, and elements of each coset consist of sequences having the same PAPR.

Accordingly, in the PAPR retriever in accordance with the present invention, in order to retrieve sequences having a minimum PAPR, sequences of the a=(0,0,a₂,a₃, . . . , aᵢ, . . . , a_{N-1}) form respectively included in different cosets, namely, sequences in which early two elements are fixed as “0,” are retrieved as shown at step S13.

In the PAPR retriever, the PAPR of sequences in which early two elements are fixed as “0” is respectively calculated. A minimum PAPR is selected from among the calculated PAPRs, and sequences having the selected minimum PAPR are detected from the sequences in which early two elements are fixed as “0,” as shown at step S15.

In the PAPR retriever, cosets in which the detected sequences are included are selected as shown at step S17, and sequences included in the selected cosets are selected as sequences having a minimum PAPR as shown at step S19. Accordingly, in the PAPR retriever, sequences having a minimum PAPR can be retrieved quickly and efficiently without calculating a PAPR of all sequences of a length N. This is accomplished by calculating a PAPR of sequences in which early two elements are fixed as “0” respectively, selecting sequences having a minimum PAPR among the calculated PAPRs, and selecting a coset in which the selected sequences are included.

In order to retrieve an input sequence having a minimum PAPR in an OFDM system using the M-PSK modulation method and having N-number of carriers, only M^{N-2} number of sequences are considered, and accordingly, complexity is reduced by M².

In order to analyze PAPR distribution of all sequences used in the OFDM system, the PAPR retriever classifies all sequences into cosets having the same PAPR characteristics by using conversion for multiplying a certain phase and conversion for shifting by a prescribed time. Because PAPRs in which the early two elements are fixed as “0” are included in different cosets, the PAPR retriever then calculates PAPR of the sequences in which the early two elements are fixed as “0.” The PAPR retriever judges PAPR of sequences of a coset having the certain sequences in which the early two elements are fixed as “0” as having the same PAPR as the certain sequences. The PAPR retriever also calculates PAPR distribution of all the sequences on the basis of the PAPR of the sequences in which the early two elements are fixed as “0” and the number of sequences in the pertinent coset. Accordingly, in the PAPR retriever, by calculating PAPRs of sequences in which the early two elements are fixed as “0” without calculating a PAPR of all sequences, PAPR distribution of the all sequences can be efficiently obtained.

In an OFDM system using the M-PSI modulation method and having N-number of carriers, in order to analyze PAPR distribution of all sequences, only M^{N-2} number of sequences are considered among the M^{N} number of sequences.

As described-above, when PAPR distribution of all sequences is analyzed, with reference to the analyzed PAPR distribution, a system designer can select sequences usable in the OFDM system so as to have a good BER (bit error rate) and a PAPR not too high. In addition, the designer can design a device such as an amplifier, an A/D converter or a D/A converter, etc. constructing the OFDM system as a device having a low dynamic range.

In the present invention, by classifying all input sequences into cosets having the same PAPR and using characteristics in which sequences having early two elements fixed as “0” are included in different cosets, it is possible to quickly and efficiently retrieve a sequence having a minimum PAPR on the basis of PAPR of the sequences having early two elements fixed as “0.”

In the present invention, by classifying all input sequences into cosets having the same PAPR and using characteristics in which sequences having early two elements fixed as “0” are included in different cosets, it is possible to retrieve PAPR distribution of all sequences quickly and efficiently on the basis of PAPR of the sequences having early two elements fixed as “0.” Accordingly, in the OFDM system having N-number of carriers and using the M-PSK modulation method, in the case of retrieving sequences having a minimum PAPR, without calculating PAPRs of the total M^{N} number of sequences, but by calculating only the M^{N-2} number of sequences, it is possible to reduce retrieving complexity. In addition, the larger the size M of the constellation used, the greater the reduction in retrieving complexity.

In the present invention, it is possible to design a device of the OFDM system having a good BER performance and a lower PAPR on the basis of PAPR distribution state of all sequences usable in the OFDM system. In addition, in the present invention, the OFDM system can be constructed as a device having a lower dynamic range.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for retrieving sequences having a minimum peak to average power ratio in an orthogonal frequency division multiplexing system, comprising:
classifying all input sequences into cosets having the same peak to average power ratio;
retrieving sequences in which early two elements are fixed as a prescribed value;
detecting sequences having a minimum peak to average power ratio among the retrieved sequences;
selecting cosets in which the detected sequences are included; and
extracting sequences included in the selected cosets.

2. The method of claim 1, wherein the prescribed value is “0.”

3. The method of claim 1, wherein sequences generated by conversion for shifting by a prescribed time on a timing axis and conversion for multiplying by a random phase are allocated to the same coset in the classifying step.

4. The method of claim 1, wherein said classifying allocates a sequence a(φ) and a sequence a^{(m)} to the same coset on the basis of a sequence a=(a₀,a₁, . . . , a_{N-1}) when the number of carriers is N and a M-PSK modulation method is used, and wherein
a(φ)=(a₀+φ, a₁+φ, . . . , a_{N-1}+φ), where φ=0,1, . . . M−1,
a^{(m)}=(a^{(m)}₀,a^{(m)}₁, . . . , a^{(m)}_{N-1}), where m=0,1,2, . . . , M−1, and
an i-th sequence of the sequence a^{(m)} is
a^{(m)}ᵢ=aᵢ+im (mod M), where i=0,1, . . . , N−1.

5. The method of claim 1, wherein said retrieving retrieves a sequence a=(0,0,a₂,a₃, . . . , a_{N-1}),where aᵢ=0,1,2, . . . M−1 when the number of carriers is N and a M-PSK modulation method is used.

6. The method of claim 1, wherein said retrieving includes:
calculating peak to average power ratios of the retrieved sequences; and
selecting a minimum peak to average power ratio among the calculated peak to average power ratios.

7. The method of claim 1, further comprising:
calculating peak to average power ratios of sequences in which the early two elements are fixed as the prescribed value; and
analyzing peak to average power ratio distribution of the all input sequences by using a number of sequences respectively allocated to cosets in which the sequences having the early two elements fixed as the prescribed value are included and using the calculated peak to average power ratios.

8. The method of claim 7, wherein the analyzed peak to average power ratio distribution is used for determining a dynamic range required for a device of the orthogonal frequency division multiplexing system.

9. A method for retrieving sequences having a minimum peak to average power ratio in an orthogonal frequency division multiplexing system, comprising:
retrieving sequences in which early two elements are fixed as “0”;
calculating peak to average power ratios of the retrieved sequences;
selecting a minimum peak to average power ratio among the calculated peak to average power ratios and detecting sequences having the minimum peak to average power ratio;
selecting cosets in which the detected sequences are included; and
generating sequences included in the selected cosets.

10. The method of claim 9, wherein sequences having the early two elements fixed as “0” are included in different cosets, and sequences included in the same coset have the same peak to average power ratio characteristics.

11. The method of claim 9, wherein said retrieving retrieves sequences a=(0,0,a₂,a₃, . . . , aᵢ, . . ., a_{N-1}) when the number of carriers is N and a M-PSK modulation method is used, and wherein aᵢ=0,1,2, . . . M−1, and i=2,3, . . . , N−1.

12. The method of claim 9, wherein said generating generates sequences having the same peak to average power ratio characteristics as the peak to average power ratio of the detected sequence by a first conversion for multiplying the detected sequence by a prescribed phase, and by a second conversion for shifting the detected sequence by a prescribed time on a timing axis.

13. The method of claim 12, wherein sequences generated by the first conversion are
a(φ)=(a₀+φ, a₁+φ, . . . , a_{N-1}+φ), where φ=0,1, . . . M−1, and
sequences generated by the second conversion are
a^{(m)}=(a^{(m)}₀,a^{(m)}₁, . . . , a^{(m)}_{N-1}), where m=0,1,2, . . . , M−1,
when the number of carriers is N and a M-PSK modulation method is used, and wherein
an i-th sequence of the sequence a^{(m)} is
a^{(m)}ᵢ=aᵢ+im (mod M), where i=0,1, . . . , N−1.

14. An apparatus for retrieving sequences having a minimum peak to average power ratio in a communication system, comprising:
a signal mapper;
a retriever; and
a modulator,
wherein input sequences are classified into cosets having the same peak to average power ratio, and sequences are extracted from selected cosets in which detected sequences are included, said detected sequences having minimum peak to average power ratio among retrieved sequences in which early two elements are a prescribed value.

15. The apparatus of claim 14, wherein said prescribed value is “0.”

16. The apparatus of claim 14, wherein sequences having said prescribed value are included in different cosets, and sequences included in the same coset have the same peak to average power ratio characteristics.

17. An apparatus for retrieving sequences having a minimum peak to average power ratio in a communication system, comprising:
a signal mapper;
a retriever; and
a modulator,
wherein sequences included in selected cosets are generated, said selected cosets including sequences having both minimum peak to average power ratio and a prescribed value for early two elements.

18. The apparatus of claim 17, wherein said prescribed value is “0.”

19. The apparatus of claim 17, wherein sequences having said prescribed value are included in different cosets, and sequences included in the same coset have the same peak to average power ratio characteristics.
